(19) United States
(12) Patent Application Publication
(10) Pub. No.: US 2012/0185253 A1
(43) Pub. Date: Jul. 19, 2012

(54) EXTRACTING TEXT FOR CONVERSION TO AUDIO

(75) Inventors: Chundong Wang, Redmond, WA (US); Philomena Lobo, Redmond, WA (US); Rui Zhou, Redmond, WA (US)

(73) Assignee: MICROSOFT CORPORATION, Redmond, WA (US)

(21) Appl. No.: 13/008,745

(22) Filed: Jan. 18, 2011

(51) Int. Cl. G10L 13/08

(52) U.S. Cl. 704/260; 704/E13.011

(57) ABSTRACT

Embodiments are disclosed that relate to converting markup content to an audio output. For example, one disclosed embodiment provides, in a computing device a method including partitioning a markup document into a plurality of content panels, and forming a subset of content panels by filtering the plurality of content panels based upon geometric and/or location-based criteria of each panel relative to an overall organization of the markup document. The method further includes determining a document object model (DOM) analysis value for each content panel of the subset of content panels, identifying a set of content panels determined to contain text body content by filtering the subset of content panels based upon the DOM analysis value of each of the content panels of the subset of content panels, and converting text in a selected content panel determined to contain text body content to an audio output.

### BACKGROUND

Web browsers and other markup document rendering applications are generally configured to present markup documents in visual form. While visually rendered web content is suitable for consumption in static locations, such presentation of markup content may not be suitable for consumption while mobile. Various methods of converting markup documents to audio outputs have been proposed. However, due to the complex layout and diverse content of many web pages, isolating text for converting to audio is challenging. As a result, undesired portions of a web page, such as advertisements, content discovery links, navigational controls, and the like may be inadvertently converted to audio.

### SUMMARY

Various embodiments are disclosed herein that relate to the conversion of markup content to an audio output. For example, one disclosed embodiment provides, in a computing device, a method of extracting text from a markup document for audio output. The method comprises partitioning the markup document into a plurality of content panels, and forming a subset of content panels by filtering the plurality of content panels based upon geometric and/or location-based criteria of each panel relative to an overall organization of the markup document. The method further comprises determining a document object model (DOM) analysis value for each content panel of the subset of content panels, identifying a set of content panels determined to contain text body content by filtering the subset of content panels based upon the DOM analysis value of each of the content panels of the subset of content panels, and converting text in a selected content panel determined to contain text body content to an audio output.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an embodiment of a markup document use environment.

FIG. 2 shows a flow diagram depicting an embodiment of a method for extracting text from a markup document for conversion to an audio output.

FIG. 3 shows an embodiment of an example layout of a markup document.

FIG. 4 shows an embodiment of a portion of an example document object model (DOM) tree of a markup document.

### DETAILED DESCRIPTION

As mentioned above, the variety of different content items that may be found within a web page or other markup document may present difficulties in the conversion of markup document text to a satisfactory audio output. For example, in addition to the text that makes up the body of an article, a web page also may include related content such as a title, a biography of the author of the article, comments on the article, and embedded video and audio, as well as unrelated content such as advertising, navigational controls and instructions, content discovery links, and the like. If such a page were converted directly to audio without any filtering of content, the listening experience may be unsatisfactory.

Therefore, embodiments are presented herein that relate to filtering content from a markup document to isolate the text body of the document, if any, for conversion to an audio output. The disclosed embodiments may help to remove such content as advertising, titles, author information, comments, and the like so that a user may listen to the text body of the document without hearing other, less desirable content from the page.

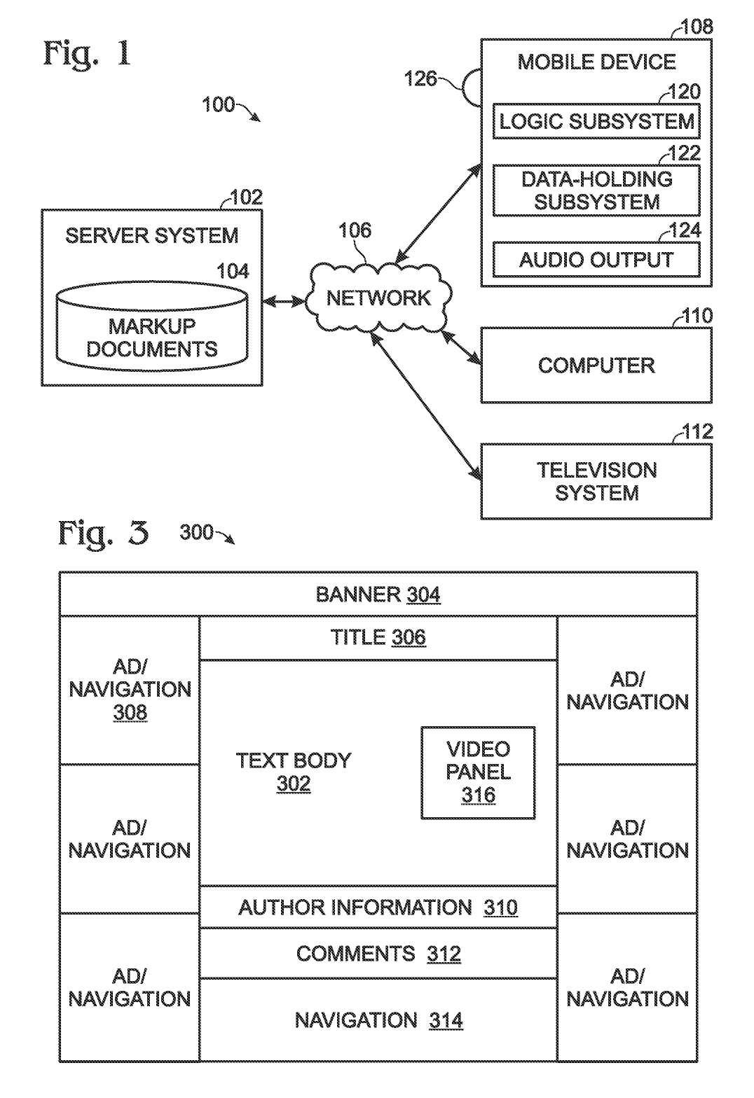

Prior to discussing these embodiments in more detail, an example use environment 100 is described with reference to FIG. 1. Use environment 100 comprises a server system 102 configured to serve content, such as markup documents 104 stored on or otherwise accessible by the server system 102, to requesting devices via a network 106. Various types of devices may request and receive markup documents from the server system 102. Examples include, but are not limited to, mobile devices 108, computers 110 (e.g. laptop computer, desktop computer, notepad computer, notebook computer, slate computer, and/or any other suitable types of computer), and television systems 112 (which may include hardware such as digital video recorders, set-top boxes, video game consoles, and the like). These devices may be referred to collectively herein as computing devices.

It will be understood that the above-described computing devices are presented for the purpose of example and are not intended to be limiting in any manner, as the embodiments described herein may be implemented on any suitable computing device. Examples include, but are not limited to, mainframe computers, server computers, desktop computers, laptop computers, tablet computers, home entertainment computers, network computing devices, mobile computing devices, mobile communication devices, gaming devices, etc.

As illustrated for mobile device 108, each of these computing devices includes a logic subsystem 120 and a data-holding subsystem 122, wherein the logic subsystem 120 is configured to execute instructions stored within the data-holding subsystem 122 to, among other tasks, implement embodiments disclosed herein. Each of these computing devices also comprises an audio output 124 configured to output an audio signal, whether in electronic or acoustic form. For example, the audio output 124 may comprise an audio transducer, such as a speaker, and/or may comprise an electronic output, such as a speaker jack, network interface, etc.

The logic subsystem 120 may include one or more physical devices configured to execute one or more instructions. For example, the logic subsystem 120 may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

The logic subsystem 120 may include one or more processors that are configured to execute software instructions. Additionally or alternatively, the logic subsystem 120 may include one or more hardware or firmware logic machines configured to execute hardware or firmware instructions. Processors of the logic subsystem may be single core or multicore, and the programs executed thereon may be configured for parallel or distributed processing. The logic subsystem 120 may optionally include individual components that are distributed throughout two or more devices, which may be remotely located and/or configured for coordinated processing. One or more aspects of the logic subsystem 120 may be virtualized and executed by remotely accessible networked computing devices configured in a cloud computing configuration.

The data-holding subsystem 122 may include one or more physical, non-transitory, devices configured to hold data and/or instructions executable by the logic subsystem to implement the herein described methods and processes. When such methods and processes are implemented, the state of the data-holding subsystem 122 may be transformed (e.g., to hold different data).

The data-holding subsystem 122 may include removable media and/or built-in devices. The data-holding subsystem 122 may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard disk drive, floppy disk drive, tape drive, MRAM, etc.), among others. The data-holding subsystem 122 may include devices with one or more of the following characteristics: volatile, nonvolatile, dynamic, static, read/write, read-only, random access, sequential access, location addressable, file addressable, and content addressable. In some embodiments, the logic subsystem 120 and the data-holding subsystem 122 may be integrated into one or more common devices, such as an application specific integrated circuit or a system on a chip.

It is to be appreciated that data-holding subsystem 122 includes one or more physical, non-transitory devices. In contrast, in some embodiments aspects of the instructions described herein may be propagated in a transitory fashion by a pure signal (e.g., an electromagnetic signal, an optical signal, etc.) that is not held by a physical device for at least a finite duration. Furthermore, data and/or other forms of information pertaining to the present disclosure may be propagated by a pure signal.

FIG. 1 also shows an aspect of the data-holding subsystem in the form of removable computer-readable storage media 126, which may be used to store and/or transfer data and/or instructions executable to implement the herein described methods and processes. Removable computer-readable storage media 126 may take the form of CDs, DVDs, HD-DVDs, Blu-Ray Discs, EEPROMs, and/or floppy disks, among others.

It will be understood that the computing devices illustrated herein may include other systems, devices and/or components not shown in FIG. 1. For example, the computing devices may include a communication subsystem configured to communicatively couple computing system with one or more other computing devices. Such a communication subsystem may include wired and/or wireless communication devices compatible with one or more different communication protocols. As nonlimiting examples, a communication subsystem may be configured for communication via a wireless telephone network, a wireless local area network, a wired local area network, a wireless wide area network, a wired wide area network, etc. In some embodiments, the communication subsystem may allow a computing device to send and/or receive messages to and/or from other devices via a network such as the Internet.

Further, the computing devices illustrated herein may include a display subsystem, user input devices such as keyboards, mice, game controllers, cameras, microphones, and/or touch screens, for example, as well as any other suitable systems, components and/or devices.

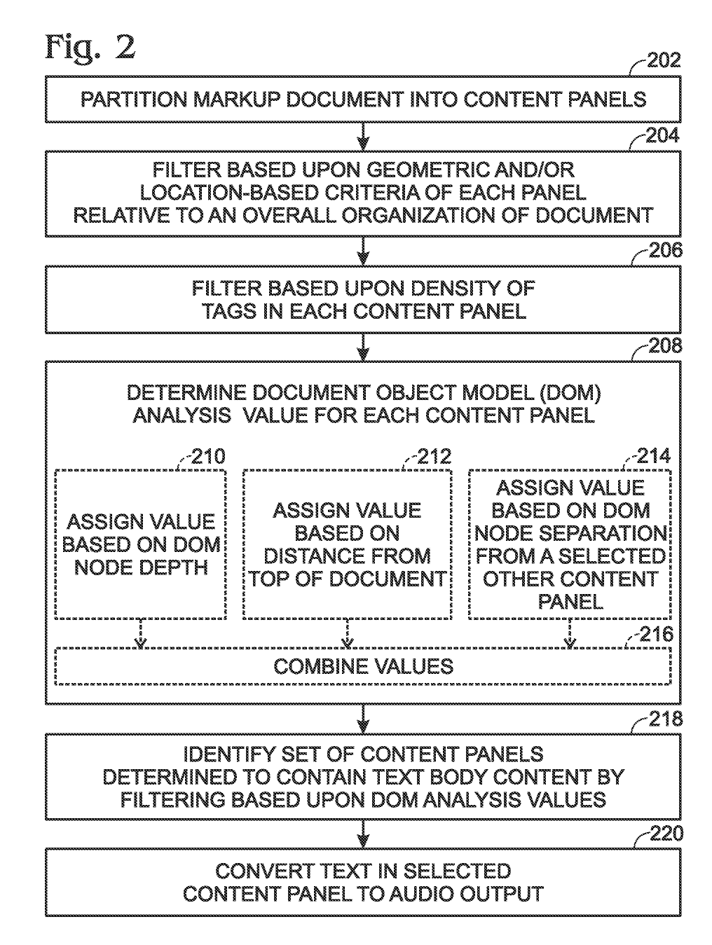

FIG. 2 shows an embodiment of a method 200 for converting a markup document to an audio output. Method 200 first comprises, at 202, partitioning the markup document into a plurality of content panels, and then, at 204, filtering the plurality of content panels based upon geometric and/or location-based criteria relative to an overall organization of the markup document. For example, markup documents such as a web pages often may, when rendered, have a particular organization that places titles, advertisements, content discovery links, content text (e.g. a text body of an article), and comments in common locations. FIG. 3 shows an example embodiment of a web page layout 300 that includes a text body panel 302 that is spaced from the sides of the layout by other panels. More specifically, a banner panel 304 and title panel 306 are positioned above the text body panel 302, advertising and/or navigation panels 308 are positioned around the text body panel 302, and an author information panel 310, comment panel 312, and navigation panel 314 are positioned below the text body panel 302. Further, it can be seen that the text body panel 302 has a larger size than the other panels.

These geometric and/or location based factors may be used to quickly filter some page titles, navigational links, advertising, banners, and other such content without examination of the content of each of these panels. Further, panels that float locally to the side of other panels, such as video panel 316, also may be filtered, as such panels may be used by web page designers to present related content such as audio, video, and/or still image content.

The filtering performed at 204 produces a first subset of content panels. After forming the first subset of content panels, other heuristics may be applied to further narrow the set of content panels to be converted to audio. For example, in the depicted embodiment, method 200 next comprises, at 206, determining a density of tags (e.g. hypertext links and other such tags) of each content panel of the first subset of content panels, and then filtering the content panels based upon the density of tags to form a second subset of panels. Filtering by a density of links may allow removal of previously unfiltered advertising, image content, and other panels with a relatively high density of tags compared to text body content of the document. The link density filtering of method 200 produces a second subset of content panels comprising “candidate paragraphs,” which is text that potentially may be content of interest.

The second subset of content panels may comprise text elements other than the text body of the document, such as comments bylines, captions, text-dense advertisements, and the like, not removed by prior filtering processes. Therefore, to remove such content panels before converting the text to audio, method 200 next comprises, at 208, determining a document object model (DOM) analysis value for each content panel of the second subset of content panels to be used to filter such text prior to audio conversion. The DOM analysis value comprises a value determined from an analysis of the DOM tree of the document, and may be determined by applying one or more heuristics or other analytical processes to quantities derived from the document DOM tree.

FIG. 2 shows three example methods of determining values for use in such a DOM analysis filtering. As explained below, a DOM analysis value used to filter the content panels may be determined from any one or more of the depicted examples, and/or any other suitable DOM analyses not shown in FIG. 2. Where the DOM analysis value is determined from a combination of values from different processes, such values may be combined in any suitable way.

Referring first to 210, a DOM analysis value for a content panel may be derived at least partially based upon a DOM node depth of the content panel in the markup document as compared to the node depth of a selected other content panel. The selected other panel may be determined in any suitable manner. For example, in some embodiments, the selected other content panel may be a next content panel in a list of content panels. In other embodiments, a selected other panel may be determined based upon a high likelihood of the selected other panel having text body content, as it may be more likely to find body text at a same DOM tree node depth as other such text than at a different DOM tree node depth.

A DOM value based upon a node depth comparison may be determined in any suitable manner. For example, in some embodiments, a first value may be assigned if the content panel has a same node depth as the selected other content panel, and a second value may be assigned if the content panel has a different node depth than the selected other content panel.

Referring next to 212, a DOM analysis value for a content panel also may be derived at least partially based upon a distance of the content panel from a top of the document, or from another geometric reference location in the document, as text body content may be more likely to be found closer to a top of a document than farther from a top of a document. In some embodiments, the actual distance value of the content panel from the top of the document may be used in determining the DOM analysis value, while in other embodiments, the distance value may be weighted based upon a magnitude of the distance value.

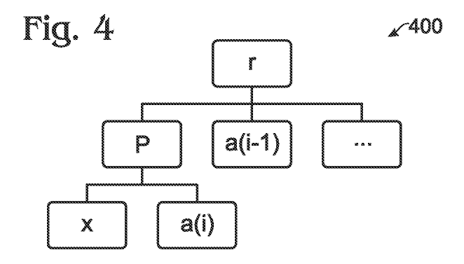

Next referring to 214, a DOM analysis value for a content panel also may be derived at least partially based upon a separation between the content panel and a selected other content panel, such as the sample content panel or panels discussed above, as a greater node depth separation of a text element from another text element having text body content may indicate a lower likelihood of the text element having text body content. Such a separation may be determined in any suitable manner. For example, in some embodiments, such a separation may be determined by subtracting a depth of the content panel from a common ancestor node and a depth of the selected other content panel from the common ancestor node. This is illustrated in FIG. 4, which shows an example embodiment of a portion of a DOM tree 400 for a document. In the depicted DOM tree 400, node a(i) has a depth of 2 from a common ancestor node r, while node a(i−1) has a depth of 1. Therefore, the separation of nodes a(i) and a(i−1) is 1. In some embodiments, this separation value may be weighted depending upon the magnitude of the separation.

As indicated at 216, in some embodiments, the DOM analysis value may be determined based upon a combination of results from two or more of processes 210, 212 and 214. One specific example of a method of determining a DOM analysis value from a combination of processes 210, 212 and 214 is as follows. Referring again to FIG. 4, the second subset of content panels (the “candidate paragraphs”) are elements aᵢ in a list A={aᵢ}, where aᵢ has a position (xᵢ,yᵢ) and a DOM node depth (1ₐᵢ). For each aᵢ, a DOM analysis value in the form of a cost function Cost(aᵢ) may be determined as follows:

Cost(aᵢ)=D(Δy)+S(aᵢ,aᵢ₋₁)*150+C(lₐ_{ᵢ},lₐ_{_{a−i}})

In this function, D(Δy) is the distance of element aᵢ from a top of the document, and may be weighted in one specific example embodiment as follows.

$$D ( Δ y ) = \{ \begin{matrix}0 & Δ y < 30 \\ 50 + \frac{Δ y}{2} & 30 \leq Δ y \leq 600 \\ Δ y & Δ y > 600\end{matrix}$$

Next, C(lₐ_{ᵢ},lₐ_{_{i−1}}) is a node depth comparison of elements a(i) and a(i−1), and in one specific embodiment may be determined as follows.

$$C ( {l}_{{a}_{i}} , {l}_{{a}_{i - 1}} ) = \{ \begin{matrix}- 80 & {l}_{{a}_{i}} = {l}_{{a}_{i - 1}} \\ \vert {l}_{{a}_{i}} - {l}_{{a}_{i - 1}} \vert * 150 & {l}_{{a}_{i}} \neq {l}_{{a}_{i - 1}}\end{matrix}$$

S(aᵢ, aᵢ₋₁) is the above described separation value, and may be determined as a depth-distance from these two nodes to a common ancient node, such as node R in FIG. 4. It will be understood that elements a(i) and a(i−1) may represent any suitable two elements in list A, and that these labels are not intended to be limiting in any manner.

Continuing with FIG. 2, after determining the DOM analysis value, a set of content panels determined to contain text body content is identified at 218 by filtering based upon DOM analysis values. For example, in the example above, such filtering may be performed by comparing each cost function result to a threshold cost value to determine whether to filter the corresponding content panel prior to audio conversion. Then, at 220, method 220 comprises converting text in a selected content panel (e.g. any or all of the content panels remaining after DOM analysis filtering) to an audio output for consumption by a user. The audio output may comprise an acoustic output, such as an output of sound from a speaker or other audio transducer, and/or an electronic output, such as a signal directed to a speaker or other audio transducer or an encoded signal sent to another computing device. In this manner, a user may consume web content and other markup documents on the go by listening to the documents instead of reading the document in text form.

In some embodiments, prior to performing the DOM analysis, it may be determined after panel partitioning and/or link density filtering whether the page has sufficient text content to be considered “readable” in that it contains body text, and then the DOM analysis may or may not be performed depending upon the result of this determination.

The embodiments disclosed herein may allow for accurate parsing of textual content from a variety of pages that are primarily textual content, including but not limited to news articles, blogs and wiki pages. The disclosed embodiments may be flexible enough to work in a variety of languages, as opposed to methods that utilize class names and/or identifications to extract text content from markup documents.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. In a computing device, a method of extracting text from a markup document for audio output, the method comprising:
partitioning the markup document into a plurality of content panels;
forming a subset of content panels by filtering the plurality of content panels based upon geometric and/or location-based criteria of each panel relative to an overall organization of the markup document;
determining a document object model (DOM) analysis value for each content panel of the subset of content panels;
identifying a set of content panels determined to contain text body content by filtering the subset of content panels based upon the DOM analysis value of each of the content panels of the subset of content panels; and
converting text in a selected content panel determined to contain text body content to an audio output.

2. The method of claim 1, wherein the subset of panels is a first subset of panels, and further comprising:
forming a second subset of content panels by filtering the first subset of content panels based upon a density of tags determined for each of the content panels of the first subset of content panels, and wherein determining the DOM analysis value for each content panel of the subset of content panels comprises determining the DOM analysis value for each content panel of the second subset of content panels.

3. The method of claim 1, wherein the DOM analysis value is determined from one or more of a DOM node depth of the content panel compared to a selected other panel, a distance of the content panel from a top of the markup document, and a DOM node separation of the content panel from the selected other content panel.

4. The method of claim 3, wherein the DOM analysis value is determined based upon a combination of the DOM node depth of the content panel, the distance of the content panel from the top of the markup document, and the DOM node separation of the content panel from the selected other content panel.

5. The method of claim 4, further comprising determining the DOM node separation by determining a depth of the content panel from a common ancestor node and a depth of the selected other content panel from the common ancestor node, and then subtracting the depth of the content panel and the depth of the selected other content panel.

6. The method of claim 4, further comprising determining the DOM node depth by assigning a first value if the content panel has a same node depth as the selected other content panel, and assigning a second value if the content panel has a different node depth than the selected other content panel.

7. The method of claim 4, further comprising determining the distance of the content panel from the top of the markup document by weighting the distance based upon a magnitude of the distance.

8. The method of claim 1, wherein the computing device comprises a mobile device.

9. The method of claim 1, wherein the computing device comprises a laptop computer, a notepad computer, a notebook computer, a desktop computer, or a television.

10. A computing device, comprising:
an audio output;
a logic subsystem; and
a data-holding subsystem comprising instructions stored thereon that are executable by the logic subsystem to output an audio rendering of a markup document by:
partitioning the markup document into a plurality of content panels;
filtering the plurality of content panels based upon geometric and/or location-based criteria of each panel relative to an overall organization of the markup document to form a subset of content panels;
determining a document object model (DOM) analysis value for each content panel of the subset of content panels from one or more of a DOM node depth of the content panel, a distance of the content panel from a top of the markup document, and a DOM node separation of the content panel from a selected other content panel;
identifying a set of content panels determined to contain text body content by filtering the subset of content panels based upon the DOM analysis value of each of the content panels of the subset of content panels; and
converting to an audio output text in a selected content panel determined to contain text body content.

11. The computing device of claim 10, wherein the subset of panels is a first subset of panels, and further comprising instructions executable to:
form a second subset of content panels by filtering the first subset of content panels based upon a density of tags determined for each of the content panels of the first subset of content panels, and then determine the DOM analysis value for each content panel of the second subset of content panels.

12. The computing device of claim 10, wherein the instructions are executable to determine the DOM analysis value from a combination of the DOM node depth, the distance of the content panel from the top of the markup document, and the DOM node separation.

13. The computing device of claim 10, wherein the instructions are executable to determine the DOM node separation by determining a depth of the content panel from a common ancestor node and a depth of the selected other content panel from the common ancestor node, and then subtracting the depth of the content panel and the depth of the selected other content panel.

14. The computing device of claim 10, wherein the instructions are executable to determine the DOM analysis value based upon the DOM node depth by assigning a first value if the content panel has a same node depth as the selected other content panel, and assigning a second value if the content panel has a different node depth than the selected other content panel.

15. The computing device of claim 10, wherein the instructions are executable to determine the DOM analysis value based upon the distance of the content panel from the top of the markup document by weighting the distance based upon a magnitude of the distance.

16. The computing device of claim 10, wherein the computing device comprises a mobile device.

17. The computing device of claim 10, wherein the computing device comprises one or more of a laptop computer, a notepad computer, a notebook computer, a desktop computer, and a television.

18. A computer-readable storage medium comprising instructions stored thereon that are executable by a computing device to perform a method of extracting text from a markup document for audio output, the method comprising:
partitioning the markup document into a plurality of content panels;
forming a first subset of content panels by filtering the plurality of content panels based upon geometric and/or location-based criteria of each panel relative to an overall organization of the markup document;
forming a second subset of content panels by filtering the first subset of content panels based upon a density of tags determined for each of the content panels of the first subset of content panels;
determining a document object model (DOM) analysis value for each content panel of the second subset of content panels from a combination of values assigned based upon a DOM node depth of the content panel, a distance of the content panel from a top of the markup document, and a DOM node separation of the content panel from a selected other content panel;
identifying a set of content panels determined to contain text body content by filtering the second subset of content panels based upon the DOM analysis value of each of the content panels of the second subset of content panels; and
converting text in a selected content panel determined to contain text body content to an audio output.

19. The computer-readable medium of claim 18, wherein the computer-readable storage medium is a removable storage medium.

20. A computing device comprising the computer-readable storage medium of claim 18.
